(19) United States
(12) Patent Application Publication
(10) Pub. No.: US 2020/0057992 A1
(43) Pub. Date: Feb. 20, 2020

(54) Distributed ledger-based supplier evaluation

(71) Applicant: SAP SE, Waldorf (DE)

(72) Inventors: Peter J. Neumayer, Edenkoben (DE); Christian Sommer, Forst (DE)

(21) Appl. No.: 15/999,492

(22) Filed: Aug. 20, 2018

(51) Int. Cl. G06Q 10/08; G06Q 10/06; G06Q 30/02; H04L 9/06

(52) U.S. Cl. CPC G06Q 10/0838; G06Q 10/06393; H04L 9/0637; G06Q 30/0282; G06Q 10/0834

(57) ABSTRACT

Methods, systems, and apparatus, including computer programs encoded on a computer storage medium, employing a permissioned distributed ledger to capture information regarding shipments and evaluations of the suppliers of these shipments. In one aspect, a method includes receiving transactional data regarding a shipment of goods from the supplier to a client; determining a score value for each of a plurality of key performance indicators (KPIs) based on the transactional data; determining an overall rating for the supplier based on a weighted aggregate of the score values and previously determined score values for previous shipments from the supplier to at least one of a plurality of clients, the previously determined score values stored to a distributed ledger; and persisting a new transaction entry for the transactional data to the distributed ledger; and providing the overall rating to a user interface.

### TECHNICAL FIELD

This specification generally relates to objective scoring metrics for key performance indicators (KPIs) stored to a distributed ledger.

### BACKGROUND

The evaluation of suppliers of goods and services is a continual process for client organizations. Suppliers may be evaluated and approved in a process involving, for example, quantitative assessment. Such evaluations may be employed to pre-qualify a supplier to supply various goods and services for a client organization. In some client organizations, evaluations may include the participation and input various internal departments and/or stakeholders. Supplier evaluation information may also be collected for the evaluations. Evaluations may be taken in the form of, for example, questionnaires, interviews and site visits. Evaluations may include appraisals of various aspects of the supplier's business, such as capacity, financials, quality assurance, organizational structure and processes and performance. Based on the information obtained from the evaluation, a supplier may be scored and approved (or not approved). Once approved, a supplier may be reevaluated on a periodic, often annual, basis for the purposes of reducing costs, mitigating risk and driving continuous improvement.

### SUMMARY

Implementations of the present disclosure are generally directed to a system to capture information regarding shipments and evaluations of the suppliers of these shipments. The information and evaluation are stored as transactions in a distributed ledger. The transactions can be evaluated to determine a score value for each supplier based on a set of KPIs. The score values can be employed by client organizations in a consortium in the evaluation and selection of the suppliers.

In a general implementation, a computer-implemented method being executed by one or more processors for determining a rating score for a supplier includes: receiving transactional data from a client. The transactional data regarding a shipment of goods from the supplier to a client. A score value is determined for each of a plurality of KPIs based on the transactional data. An overall rating for the supplier is determined based on a weighted aggregate of the score values and previously determined score values for previous shipments from the supplier to at least one of a plurality of clients. The previously determined score values having been stored to a distributed ledger. A new transaction entry for the transactional data is persisted to the distributed ledger. The new transaction entry including the score values for each of the KPIs and the overall rating. The overall rating is provided to a user interface (UI).

In another general implementation, one or more non-transitory computer-readable storage media coupled to one or more processors and having instructions stored thereon which, when executed by the one or more processors, cause the one or more processors to perform operations that include: receiving transactional data from a client. The transactional data regarding a shipment of goods from the supplier to a client. A score value is determined for each of a plurality of KPIs based on the transactional data. An overall rating for the supplier is determined based on a weighted aggregate of the score values and previously determined score values for previous shipments from the supplier to at least one of a plurality of clients. The previously determined score values having been stored to a distributed ledger. A new transaction entry for the transactional data is persisted to the distributed ledger. The new transaction entry including the score values for each of the KPIs and the overall rating. The overall rating is provided to a UI.

In yet another general implementation, a system includes one or more processors; and a computer-readable storage device coupled to the one or more processors and having instructions stored thereon which, when executed by the one or more processors, cause the one or more processors to perform operations that include: receiving transactional data from a client. The transactional data regarding a shipment of goods from the supplier to a client. A score value is determined for each of a plurality of KPIs based on the transactional data. An overall rating for the supplier is determined based on a weighted aggregate of the score values and previously determined score values for previous shipments from the supplier to at least one of a plurality of clients. The previously determined score values having been stored to a distributed ledger. A new transaction entry for the transactional data is persisted to the distributed ledger. The new transaction entry including the score values for each of the KPIs and the overall rating. The overall rating is provided to a UI.

An aspect combinable with the general implementations, the method or operations include prompting a user to enter an evaluation of the shipment, and receiving, from the UI, an evaluation for the shipment. The new transaction entry includes the evaluation.

In an aspect combinable with any of the previous aspects, prompting the user includes sending, to the user, an email message or a text message about the shipment

In an aspect combinable with any of the previous aspects, the method or operations include determining respective ratings scores for other suppliers of the goods from other transaction entries in the distributed ledger for previous shipments from the other suppliers to the clients, and providing the respective ratings scores for the other suppliers to the UI.

In an aspect combinable with any of the previous aspects, the KPIs include delivery time accuracy, delivery quantity accuracy, and price accuracy.

In an aspect combinable with any of the previous aspects, the clients are in a consortium of participating client organizations.

In an aspect combinable with any of the previous aspects, the transactional data is received through an application programing interface (API) service.

In an aspect combinable with any of the previous aspects, the transactional data is received based on a triggering of a smart contract condition.

In an aspect combinable with any of the previous aspects, the transactional data includes an arrival time and date, a quantity of the shipment, a price point of the shipment, purchase order data, goods receipt data, or invoice data.

In an aspect combinable with any of the previous aspects, the method or operations include providing the overall rating to a client application through an API service.

In an aspect combinable with any of the previous aspects, the plurality of clients includes the client.

Particular implementations of the subject matter described in this disclosure can be implemented so as to realize one or more of the following advantages. The described supplier evaluation system establishes trust between participants without a central authority though the use of a distributed ledger that is secured by cryptography and a consensus algorithm. Moreover, collaborative scenarios are simplified through decentralized control and direct peer-to-peer interaction. The described system also increases transparency, auditability, and regulatory compliance through the employment of immutability of records. The described supplier evaluation system provides for the real-time value transfers of digital assets and incorporates system-enforced intercompany business rules through, for example, smart contracts. Additionally, the described system reduces risk without intermediaries and can provide evaluation data regarding a supplier to an entity before the parties engage in business with one another.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example environment that can be employed to execute implementations of the present disclosure.

FIG. 2 depicts an example supplier evaluation system.

FIG. 3 depicts a flow diagram of an example process that is employed for a user to provide, to a supplier evaluation system supplier, an evaluation of a transaction or for a supplier overall.

FIGS. 4A-4B depict a flow diagrams of an example processes for supplier evaluation and selection.

FIG. 5 depicts a flow diagram of an example process employed within a supplier evaluation system.

FIG. 6 depicts a block diagram of an exemplary computer system that can be employed to execute implementations of the present disclosure.

### DETAILED DESCRIPTION

Implementations of the present disclosure are generally directed to a supplier evaluation system that may be employed by various clients and/or potential clients. More particularly, implementations of the present disclosure are directed to persisting shipment data as transactions to a distributed ledger. The ledger transactions including objective scoring metrics weighted according to a series of selected key performance indicators for the suppliers of goods and/or services in a market sector or for particular supply chain. The system enables clients (e.g., purchasers) to evaluate suppliers respective to one another based on the scoring values, which are aggregates from a number of clients that receive goods from the suppliers and who are participating in a consortium to share transaction data. Thus, clients are able to evaluate potential suppliers before engaging in business with them.

Evaluating suppliers of various goods and/or services by an organization may involve an internal process to support price negotiations or the identify performance issues regarding quality or delivery accuracy. For example, internal transactional data, such as, purchase orders, goods receipts, and quality inspections may be used to calculate KPIs to assess a supplier. By comparing this compiled information with external benchmarks organizations can broaden the scope of the evaluation process. However, even when supplier evaluations are shared between organizations, varying KPIs may be employed by each of the organizations thus reducing the usability of the data. Furthermore, some sensitive information may not be released to outside of an organization based on, for example, data protection protocols and procedures.

To provide context for implementations of the present disclosure, the described system can be employed by an organization acting as clients of suppliers within various supply chains. In some implementations, suppliers provide goods (e.g., parts, widgets) and/or services to their clients. Evaluations of the deliveries of these goods is recorded based on established KPIs. A potential client may employ the described supplier evaluation system to evaluate a supplier based on information aggregated and analyzed from other clients of the supplier. Current customers of a supplier may also employ the described supplier evaluation system to evaluate the supplier. For example, the supplier may be evaluated based its performance with the client respective to other similar suppliers. As another example, the supplier may be evaluated based how it is performing for the client as compared to the supplier's performance for other clients. It is contemplated, however, that implementations of the present disclosure can be realized in any appropriate context.

In some implementations, the described supplier evaluation system employs a distributed ledger. An example distributed ledger is the commonly known Blockchain (or blockchain). Blockchain is referenced within the present disclosure for purposes of illustration. It is contemplated, however, that any appropriate distributed ledger can be used in implementations of the present disclosure. A blockchain is a (e.g., private) ledger of transactions that have been executed in one or more contexts (e.g., score calculations based on various KPIs, negotiable instrument transactions, digital currency transactions, and so forth). A blockchain may grow as completed blocks are added with a new set of transactions. In some examples, a single block is provided from multiple transactions (e.g., multiple deposits of different checks by different people). In general, blocks are added to the blockchain in a linear, chronological order by one or more computing devices in a peer-to-peer network of interconnected computing devices that execute a blockchain protocol. In short, the peer-to-peer network can be described as a plurality of interconnected nodes, each node being a computing device that uses a client to validate and relay transactions (e.g., deposits of checks). Each node maintains a copy of the blockchain, which is automatically downloaded to the node upon joining the peer-to-peer network. The blockchain protocol provides a secure and reliable method of updating the blockchain, copies of which are distributed across the peer-to-peer network, without use of a central authority.

Because all entities on the blockchain network may need to know all previous transactions (e.g., deposits, withdrawals, and so forth.) to validate a requested transaction, entities must agree on which transactions have actually occurred, and in which order. For example, if two entities observe different transaction histories, they will be unable to come to the same conclusion regarding the validity of a transaction. The blockchain enables the entities to come to an agreement as to transactions that have already occurred, and in which order. In short, and as described in further detail below, a ledger of transactions is agreed to based on the amount of work required to add a transaction to the ledger of transactions (e.g., add a block to the blockchain). In this context, the work is a task that is difficult for any single node (e.g., computing device) in the peer-to-peer network to quickly complete, but is relatively easy for a node (e.g., computing device) to verify.

A private blockchain network may require, for example, an invitation and must be validated by either the network starter or by a set of rules put in place by the network starter. Entities that set up a private blockchain, will generally set up a permissioned network. Such a network places restrictions on who is allowed to participate in the network, and/or the data to which each entities is allowed access. For example, participants is a permissioned network need to obtain an invitation or permission to join. The access control mechanism may vary. For example, existing participants may decide future entrants, a regulatory authority may issue licenses for participation or a consortium could make the decisions instead. Once an entity has joined the network, it may then play a role in maintaining the blockchain in a decentralized manner.

In some implementations, validation of transactions includes verifying digital signatures associated with respective transactions. For a block to be added to the blockchain, proof of work must be demonstrated before a proposed block of transactions is accepted, and is added to the blockchain. A blockchain protocol includes a proof of work scheme that is based on a cryptographic hash function (CHF). An example CHF includes the secure hash algorithm 256 (SHA-256). In general, the CHF receives information as input, and provides a hash value as output, the hash value being of a predetermined length. For example, SHA-256 outputs a 256-bit (32-byte, 64-character) hash value. In some examples, the hash value is a one-way hash value, in that the hash value cannot be ‘un-hashed’ to determine what the input was. The blockchain protocol can require multiple pieces of information as input to the CHF. For example, the input to the CHF can include a reference to the previous (most recent) block in the blockchain, details of the transaction(s) that are to be included in the to-be-created block, and a nonce value (e.g., a random number used only once). The blockchain protocol provides a threshold hash to qualify a block to be added to the blockchain. For example, the threshold hash can include a predefined number of zeros (0's) that the hash value must have at the beginning (e.g., at least the first four characters of the hash value must each be zero). The higher the number of zeros, the more time-consuming it is to arrive at a qualifying hash value.

In some cases, the distributed ledger or blockchain system can include one or more sidechains. A sidechain can be described as a blockchain that validates data from other blockchains. In some examples, a sidechain enables ledger assets (e.g., a digital currency) to be transferred between multiple blockchains.

In view of the foregoing, and as described in further detail herein, implementations of the present disclosure provide a system for the evaluation of suppliers to a consortium of participating client organizations. In some implementations, the supplier evaluation system actively calculates and updates supplier rating using information stored to a private distributed ledger. The use of a distributed ledger provides both transparency and auditability of stored and calculated supplier data to establish trust between participants without a central authority. As described above, the distributed ledger employed by the system is secured by cryptography and a consensus algorithm and provides for regulatory compliance through, for example, immutability of records. In some implementations, the distributed ledger stores the ratings of the suppliers that were inserted by, for example, supplier evaluation systems of the different buyers.

The supplier evaluation system provides and controls access to the supplier ratings stored in the respective distributed ledge to the various consortium participants. Participating clients may have copies of the ledge nodes, and may also serve as miners for node validation, such as described above. In some implementations, the supplier ratings are based on KPIs, such as delivery and price accuracy. Participating clients may employ the supplier evaluation system to evaluate a supplier base on both internal and external data employed to generate supplier ratings (e.g., based on a scoring protocol). The supplier evaluation system can be updated with supplier ratings in real time based on the latest evaluation data provided by the participants in the consortium.

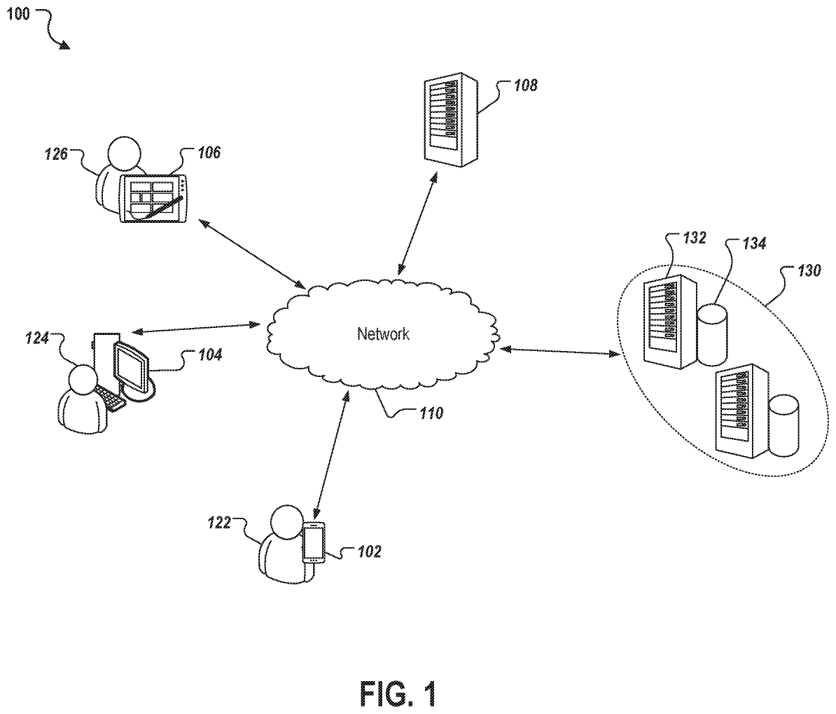

As used herein, the term “real-time” refers to transmitting or processing data without intentional delay given the processing limitations of a system, the time required to accurately obtain data and images, and the rate of change of the data and images. In some examples, “real-time” is used to describe the presentation of information obtained from components of a distributed-ledger based system, such as depicted in FIGS. 1-6.

FIG. 1 depicts an example environment 100 that can be employed to execute implementations of the present disclosure. The example system 100 includes computing devices 102, 104, 106, 108, a back-end system 130, and a network 110. In some implementations, the network 110 includes a local area network (LAN), wide area network (WAN), the Internet, or a combination thereof, and connects web sites, devices (e.g., the computing devices 102, 104, 106, 108) and back-end systems (e.g., the back-end system 130). In some implementations, the network 110 can be accessed over a wired and/or a wireless communications link. For example, mobile computing devices (e.g., the smartphone device 102 and the tablet device 106), can use a cellular network to access the network 110. In some examples, the users 122-126 may be working as agents for one of the participating clients in the consortium, such as described above. In some examples, the users 122-126 may be working as agents for different clients in the consortium.

In the depicted example, the back-end system 130 includes at least one server system 132 and a data store 134. In some implementations, the at least one server system 132 hosts one or more computer-implemented services employed within a supplier evaluation system, such as a supplier transaction upload service, that users 122-126 can interact with using the respective computing devices 102-106. For example, the computing devices 102-106 may be used by respective users 122-126 to upload transaction data for a supplier and/or to view supplier scores and/or ranking based on provided criteria over the network 110 through services hosted by the back-end system 130. In some implementations, the back-end system 130 provides an API services with which the server computing device 108 may communicate. For example, the server computing device 108 may upload information about supply transactions as they are processed by various clients.

In some implementations, the back-end system 130 may include server-class hardware type devices. In some implementations, the back-end system 130 includes computer systems using clustered computers and components acting as a single pool of seamless resources when accessed through the network 110. For example, such implementations may be used in a data center or a storage area network (SAN) as well as for cloud computing or network attached storage (NAS) applications. In some implementations, the back-end system 130 is deployed using a virtual machine(s).

The computing devices 102, 104, 106 may each include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In the depicted example, the computing device 102 is provided as a smartphone, the computing device 104 is provided as a desktop computing device, and the computing device 106 is provided as a tablet-computing device. The server computing device 108 may each include any appropriate type of computing device, such as described above for computing devices 102-106 as well as computing devices with server-class hardware. In some implementations, the server computing device 108 may include computer systems using clustered computers and components to act as a single pool of seamless resources. It is contemplated, however, that implementations of the present disclosure can be realized with any of the appropriate computing devices, such as those mentioned previously.

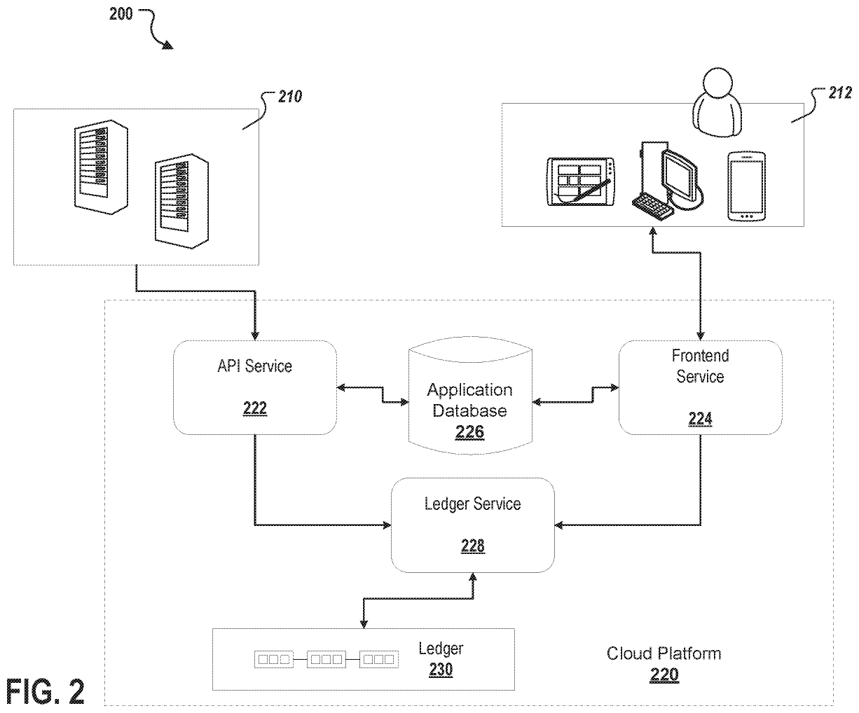

FIG. 2 depicts an example supplier evaluation system 200. As depicted, the example system 200 includes a cloud platform 220, client servers 210, and client devices 212. The cloud platform 220 includes API service 222, frontend service 224, application database 226, ledger service 228, and distributed ledger 230. In some implementations, the cloud based platform 220 provides instances of cloud-based services hosted by a back-end system, such as back-end system 130 of FIG. 1. The client servers 210 represent a grouping of server computing devices, such as server computing device 108 of FIG. 1. The client devices 212 represent groupings of computing devices that can be employed by agents of a client, such as computing devices 102-106 of FIG. 1, to provide feedback for various shipments from a supplier. The services provides by the cloud platform 220 (e.g., API service 222, frontend service 224, and ledger service 228) may be implemented, for example, by open standards and are able to be run on any cloud infrastructure provider. Only one grouping of servers 210 and client devices 212 is depicted in FIG. 2; however, each client in the consortium may have multiple grouping of client servers and/or client devices that may be employed to provide data to the services provide through the cloud platform 220.

As described above, clients that join the consortium may employ the example supplier evaluation system 200 to compare suppliers based on the experiences and feedback of other market participants. The example supplier evaluation system 200 may build ratings for suppliers based on objective criteria to standardized supplier evaluation. This data is aggregated and stored in the distributed ledger 230 and may be accessed by clients through the frontend service 224 when, for example, selecting a supplier. The objective criteria can be automatically derived from existing logistic documents, such as purchase orders or invoices. In some implementations, the objective criteria may be standardized across a group of clients in a consortium or for suppliers in a particular market or supply chain.

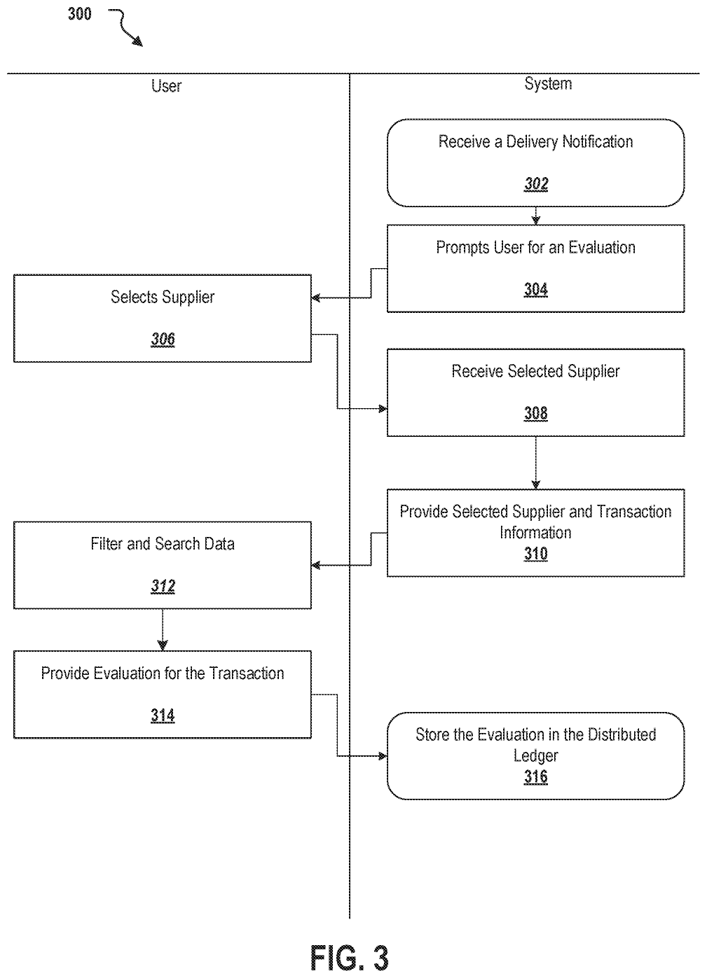

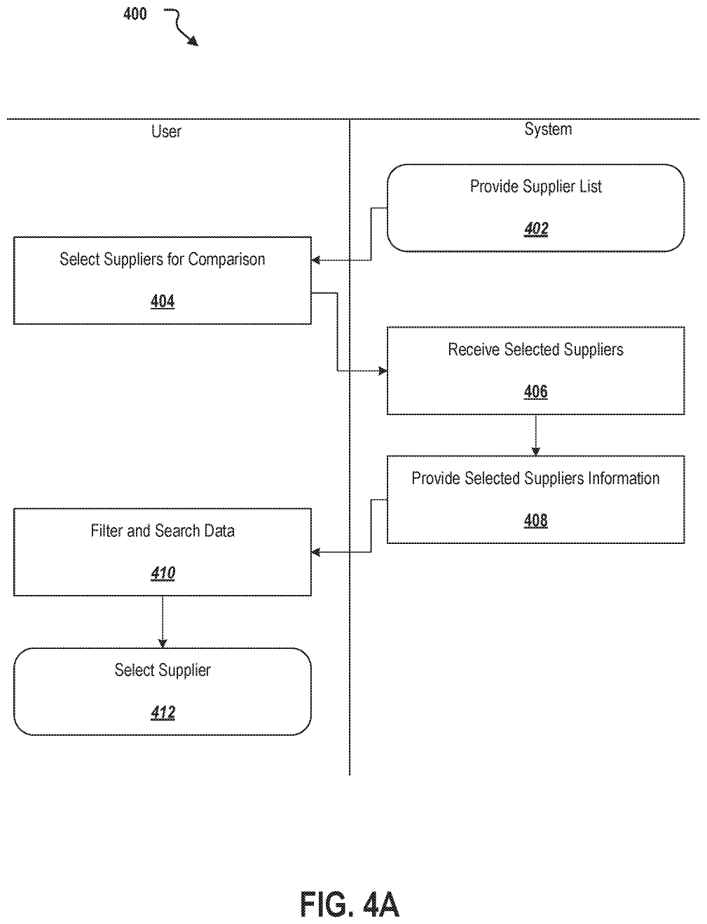

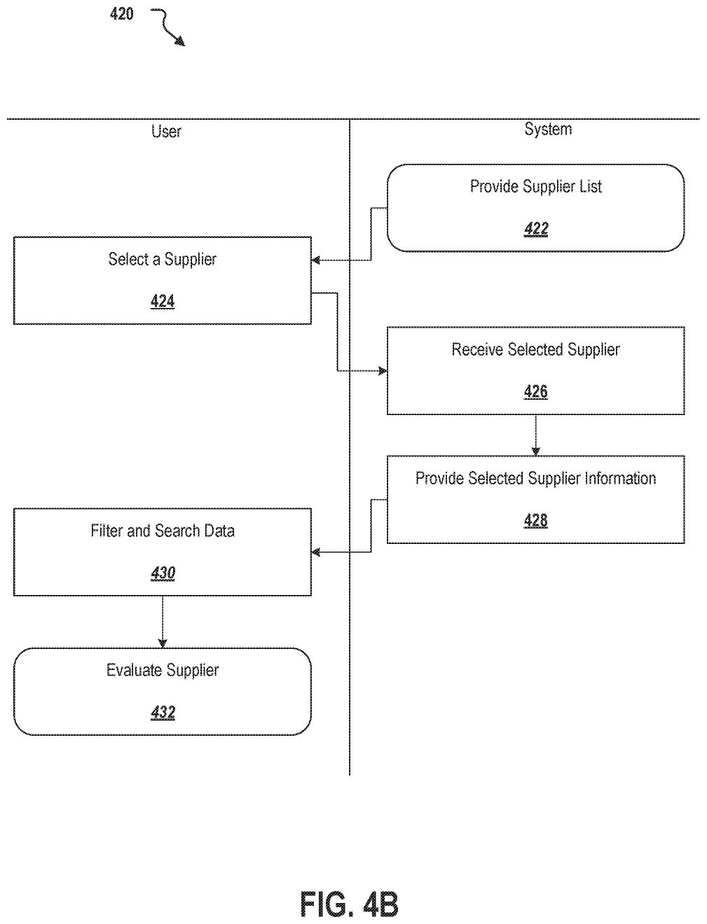

In some implementations, the frontend service 224 is provides a UI, such as a web-based UI, to access the supplier information stored on the ledger 230. Such information may include score values calculated for each supplier based on feedback provide by the clients in the consortium scored according to a set of KPIs. The frontend service 224 may also access and update user information that is stored on in the application database 226. The frontend service 224 may also be used to provide information regarding requested suppliers. For example, a user may request through the frontend service 224 a scoring and/or ranking of suppliers of a particular good or service. As another example, a user may request through the frontend service 224 the feedback or scoring from other clients for a particular supplier. See the descriptions of FIGS. 3, 4A, and 4B for a more detail discussion of these use cases. The application database 226 may be any suitable type of data storage, such as a cloud service, data warehouse, distributed big data platform, relational database, and so forth. In some implementations, user may provide feedback for a supplier through the frontend service 224. The feedback may be tagged as extra information that can be provided in requests for data regarding a supplier, but may not be included in the scoring/rating for a supplier.

In some implementations, the API services 222 provide access to the distribute ledger 230. For example, the client servers 210 may provide information regarding a shipment of a good from a supplier. This information may be employed by the supplier evaluation system 200 to prompt an agent of the client to provide feedback through the frontend service 224 regarding the supplier and the particular shipment (See FIG. 3). An agent may provide an evaluation of the shipment and/or the supplier based on various criteria. For example, the criteria may include reliability of the shipment (e.g., arrival the time and the date compared when the shipment was ordered and/or the provided estimated arrival time and date in a purchase order), the quantity of the shipment, and the price point of the goods shipment. In some implementations, this criteria may be automatically provided by the client server 210 as each shipment is completed.

In some implementations, the ledger service 228 provides access to the distributed ledger 230. For example, a node may be generated based on information regarding a shipment from a supplier supplied through the frontend service 224. This data can be employed by the ledger service 228 to generate a new block in the ledger 230, which can be verified. Once the block is validated the respective score/currency of the supplier is updated based on the block in the distributed ledger 230.

In some implementations, the supply data may be collected automatically by the ledger service 228 by using smart contracts (e.g., program code executed on the ledger or blockchain network). By this, the ledger service 228 can enforce certain business rules or executer business logic independent of the backend systems of the participants. In some implementations, various components of the ledger service 228 can be delegated to the ledger 230 as a smart contract. Not only can such smart contracts restrict the access to, for example, stored supplier data, but a smart contract can also run calculations on raw data, provide aggregated KPIs according to agreed rules, trigger actions, and so forth. One advantage of smart contracts are that they cannot be changed by a single participant. Moreover, the embedded program code is also protected against manipulations by the same mechanisms that protect the data entries to the ledger 230.

As an example, ledger service 228 may aggregate the supplier data anonymously and update the ledger 230 with the aggregated information based on a condition being triggered. Such a trigger may include, for example, when a final invoice is received or when a final delivery is made to a client. In such examples, the information regarding the shipment, such has what was ordered, what was received, what was invoiced, and what was to be provided to or collected by the ledger service 228 to generate a block for the respective supplier in the distributed ledger 230.

The ledger service 228 may also integrate with an Enterprise Resource Planning (ERP) system for each client in the consortium to facilitate the creation and execution a smart contracts in the supplier evaluation system 200. Components and/or services for of an ERP system may be provided through the client servers 210. An ERP system integrates business functions into one complete system to streamline processes and information across an organization. Example business functions include inventory, order management, accounting, human resources, customer relationship management (CRM), and so forth. In some implementations, each data point of supplier evaluation data is signed on a technical level by the party who made the entry on the blockchain (e.g. with a private certificate). Moreover, smart contracts, such as discussed above, can be employed as the interface to retrieve aggregated KPIs to maintain data privacy and business relationships secret. Such smart contracts may, for example, calculate overall scores and KPIs and returns the calculated values instead of the data points used in the calculation. Such implementations, provide for consistent calculation schemes and increased data privacy.

The ledger 230 provides a verifiable and transparent, standardized rating system for suppliers. As such, the ledger 230 keeps records of the transactions and feedback provided by clients for each supplier accessible by the example system 200. In some implementations, evaluation data is written to the blockchain and aggregated in the blockchain, taking data privacy aspects into account. In some implementations, clients can provide a score value for each KPI and a value for a particular transaction as well as the supplier overall. A block may also store additionally information for a supplier (e.g., this supplier should be blocked because it is no longer in business). In some implementations, a score includes an evaluation of the transactional data between, for example, a supplier and buyer. As an example, a score value between 0-100 may be defined. In such an example, a defined deviation of 10 percent may map to a 15 percent reduction in a score values based on a weighted scale. (e.g., ordered was for 50 units, delivery was 45, the calculated is 85). Several scores (e.g., quantity accuracy, date accuracy, and so forth) may be aggregate to a delivery accuracy KPI that is a weighted average of each. For example, a score may be weighted according to 40 percent toward date accuracy and a 60 toward quantity accuracy.

In some implementations, records of current scores and KPI's calculated and updated based on transactions and feedback are stored to the ledger 230. Such records are accessible by client systems 212 and 210 based on, for example, the permissioned granted to each entity respectively. In some implementations, clients can provide product category information to calculate KPIs per category.

In some implementations, a single supplier evaluation blockchain network is provided through Ledger Service 220. Depending on the blockchain technology of choice and the underlying the data model, supplier data may be collected in a structured way for easy KPI calculation and retrieval. For example, for a MultiChain™ implementation, so-called Streams (containers for key-value pairs) for each supplier may be employed to collected supplier data.

In some implementations, a copy of the ledger 230 can be kept with clients in the consortium and is constructed as a totally ordered chain of blocks of (valid or invalid) transactions. The ordered chain of block imposes the total order of blocks in the ledger 230, and as such, imposes a total order across all transactions.

FIG. 3 depicts a flow diagram of an example process 300 that is employed for a user to provide, to a supplier evaluation system supplier, an evaluation of a transaction or for a supplier overall. For clarity of presentation, the description that follows generally describes the process 300 in the context of FIGS. 1, 2, and 6. However, it will be understood that the process 300 may be performed, for example, by any other suitable system, environment, software, and hardware, or a combination of systems, environments, software, and hardware as appropriate. In some implementations, various operations of the process 300 can be run in parallel, in combination, in loops, or in any order.

At 302, a service, such as API service 222 of FIG. 2, may receive data from a server, client servers 210, regarding a completed transaction for a client from a supplier. From 302, the process 300 proceeds to 304.

At 304, a designated user for the client is prompted to provide an evaluation for the transaction. In some implementations, the user may be sent for example, an email or text notification or the notification may be added as a task for the user though a workflow. The user data may be stored in an application databased, such as application database 226 of FIG. 2. The user data may be selected based on the type of the transaction or the particular supplier (e.g., the use may be assigned to provide information for transactions from a particular supplier and/or for transaction for a particular type of good or service). For 304, the process 300 proceeds to 306.

At 306, the user selects the supplier of the transaction through a user interface provide through a frontend service, such as frontend service 224 of FIG. 2. In some implementations, the notification that was proved to the user may include information about the prompting transaction. Such information, may include the supplier's information. In other implementations, the user interface may access pending transactions from which the user may select the supplier. From 306, the process 300 to 308.

At 308, the system receives the selected supplier and retrieves information about the supplier from the application database and/or current scoring information stored in a distributed ledger, such as distributed ledger 230 of FIG. 2. For 308, the process 300 proceeds to 310.

At 310, the supplier information and the transaction information is provided to the user. In some implementations, the supplier information is provided though the user interface. From 310, the process proceeds to 312.

At 312, the user filters and searches through the provided supplier and transaction data. From 312, the process 300 proceeds to 314.

At 314, the user provides feedback based for the supplier overall or for the particular transaction. In some implementations, the feedback may be based on KPIs that are selected for the supplier, the type of supplier, and/or the goods or services provided in the transactions. From 314, the process 300 proceeds to 316.

At 316, the system stored the provided feedback in a distributed ledger. In some implementations, a score is generated based on the provided feedback and the respective KPIs as described above. A block may be generated based on the current state of the distributed ledger, the transaction data, the feedback, and/or the generated score value. The block may then be added to the leger when the suppliers overall score is updated based on the contents of the distributed ledger. From 316, the process 300 ends.

FIG. 4A depicts a flow diagram of an example process 400 that is employed for a user to evaluate suppliers based feedback provided by clients that are member of a consortium, such as described above. For example, process 400 may be employed to evaluate suppliers of a certain good or product. For clarity of presentation, the description that follows generally describes the process 400 in the context of FIGS. 1, 2, and 6. However, it will be understood that the process 400 may be performed, for example, by any other suitable system, environment, software, and hardware, or a combination of systems, environments, software, and hardware as appropriate. In some implementations, various operations of the process 400 can be run in parallel, in combination, in loops, or in any order.

At 402, the system provides the user with a list of suppliers through a user interface provide through a frontend service, such as frontend service 224 of FIG. 2. In some implementations, the list of suppliers is provided based on selection criteria entered be the user, such as a type of good or service that is provided. In some implementations, the list of suppliers may be provide based on a workflow for the user. From 402, the process 400 proceeds to 404.

At 404, the user selects a set of suppliers from the provided list to compare to one another based on, for example, scores and/or rankings stored in a distributed ledger, such as distributed ledger 230. For example, the user may select a subset of suppliers based on various selection criteria, such as location, approved supplier status, and so forth. From 404, the process 400 proceeds 406.

At 406, the system receives the selected suppliers from the user interface. From 406, the process proceeds to 408.

At 408, the system retrieves information about the suppliers from an application database, such as the application database 236 of FIG. 2, and/or current scoring information stored in the distributed ledger. From 408, the process 400 proceeds to 410.

At 410, the user reviews the supplier information from the user interface. In some implementations, the user may categorize and filter the provide data based on KPIs and/or selection criteria via the user interface. From 410, the process 400 proceeds to 412.

At 412, the user selects a supplier based on the provided information. For example, the user may select a supplier with that highest ranking based on a set of KPIs selected by the user. From 412, the process 400 ends.

FIG. 4B depicts a flow diagram of an example process 420 that is employed for a user to evaluate suppliers based feedback provided by clients that are member of a consortium, such as described above. For example, process 420 may be employed to conduct a periodic assessment of suppliers to compare ratings and to take the market view into account. Process 400 may also be employed to compile, for example, a supplier fact sheet. For clarity of presentation, the description that follows generally describes the process 420 in the context of FIGS. 1, 2, and 6. However, it will be understood that the process 420 may be performed, for example, by any other suitable system, environment, software, and hardware, or a combination of systems, environments, software, and hardware as appropriate. In some implementations, various operations of the process 420 can be run in parallel, in combination, in loops, or in any order.

At 422, the system provides the user with a list of suppliers through a user interface provide through a frontend service, such as frontend service 224 of FIG. 2. In some implementations, the list of suppliers is provided based on the current suppliers for a client. In some implementations, the list of suppliers may be provide based on a workflow for the user. From 422, the process 420 proceeds to 424.

At 424, the user selects a supplier from the provided list to compare the evaluation date from the user's organization with other clients of the supplier that are members of the consortium based on, for example, scores and/or rankings stored in a distributed ledger, such as distributed ledger 230. From 424, the process 420 proceeds 426.

At 426, the system receives the selected supplier from the user interface. From 426, the process 420 proceeds to 428.

At 428, the system retrieves information about the supplier from an application database, such as the application database 236 of FIG. 2, and/or current scoring information stored in the distributed ledger. From 428, the process 420 proceeds to 430.

At 430, the user reviews the supplier information from the user interface. In some implementations, the user may categorized and filter the provide data based on KPIs and/or selection criteria via the user interface. In some implementations, the scoring information may be presented to the user based on the client that provided the feedback. For example, the supplier's overall score for each client may be presented to the user. Additionally, the user may select weighted values for each client based, for example, market share or how similar in size the client is as compared to the user's organization. In some examples, the weighted values for the clients may be determined based on default values that are configurable at a system level. From 430, the process 420 proceeds to 432.

At 432, the user evaluated the supplier based on the provided information. For example, the user may determine that the supplier has a higher or lower ranking from the respective organization so as to warrant further investigation. From 432, the process 420 ends.

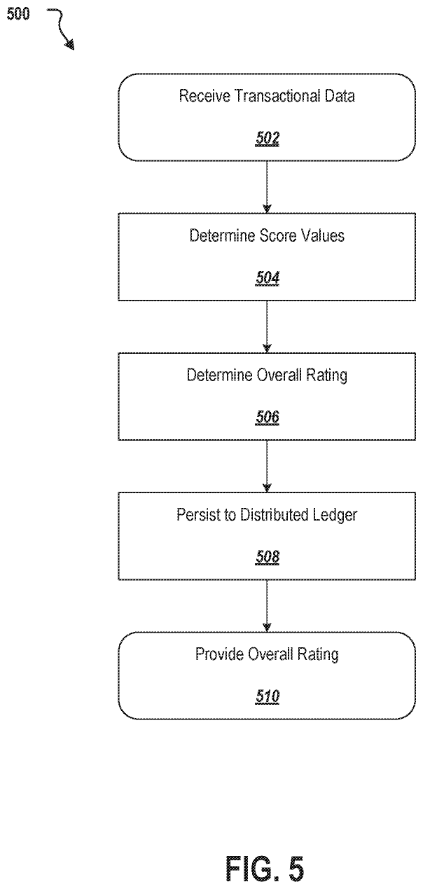

FIG. 5 depicts a flow diagram of an example process 500 employed within a supplier evaluation system. The example process 500 can be employed to determining a rating score for a supplier. For clarity of presentation, the description that follows generally describes process 5 in the context of FIGS. 1-4B and 6. However, it will be understood that process 500 may be performed, for example, by any other suitable system, environment, software, and hardware, or a combination of systems, environments, software, and hardware as appropriate. In some implementations, various steps of the process 500 can be run in parallel, in combination, in loops, or in any order.

At 502, transactional data regarding a shipment of goods from a supplier to a client is received from a client. In some implementations, the transactional data is received through an API service. In some implementations, the transactional data is received based on a triggering of a smart contract condition. In some implementations, the transactional data includes an arrival time and date, a quantity of the shipment, a price point of the shipment, purchase order data, goods receipt data, or invoice data. From 502, the process 500 proceeds to 504.

At 504, a score value for each of a plurality of KPIs is determined based on the transactional data. In some implementations, the KPIs include delivery time accuracy, delivery quantity accuracy, and price accuracy. From 504, the process 500 proceeds to 506.

At 506, an overall rating for the supplier is determined based on a weighted aggregate of the score values and previously determined score values for previous shipments from the supplier to at least one of a plurality of clients. The previously determined score values is stored to the distributed ledger. In some implementations, the clients are in a consortium of participating client organizations. In some implementations, the plurality of clients includes the client. From 506, the process 500 proceeds to 508.

At 508, a new transaction entry for the transactional data is persisted to the distributed ledger. The new transaction entry includes the score values for each of the KPIs and the overall rating. In some implementations, a user is prompted to enter an evaluation of the shipment and an evaluation for the shipment is received from a UI. In such implementations, the new transaction entry includes the evaluation. In some implementations, the user is prompted by sending, to the user, an email message or a text message about the shipment. From 508, the process 500 proceeds to 510.

At 510, the overall rating is provided to a UI. In some implementations, respective ratings scores are determined for other suppliers of the goods from other transaction entries in the distributed ledger for previous shipments from the other suppliers to the clients. In such implementations, the respective ratings scores for the other suppliers are provided to the UI. In some implementations, the overall rating is provided to a client application through an API service. From 510, the process 500 ends.

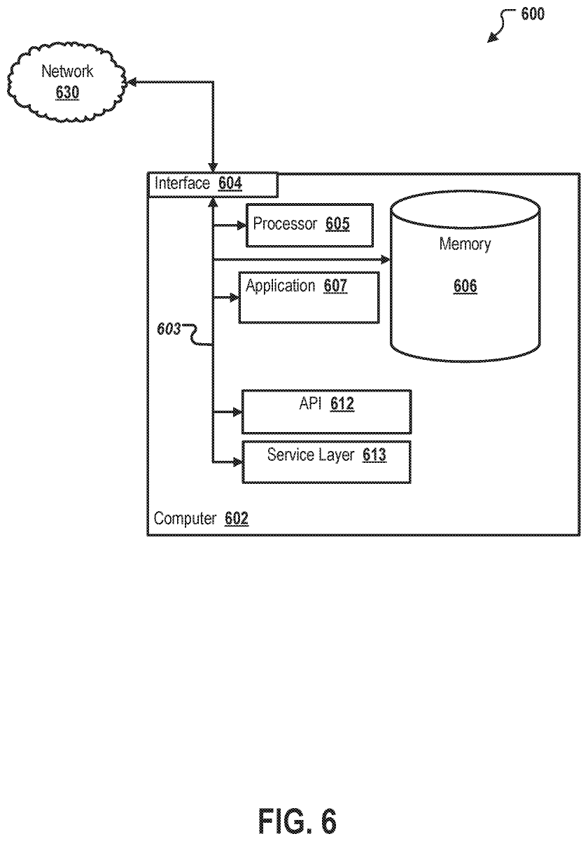

FIG. 6 depicts a block diagram of an exemplary computer system 600 used to provide computational functionalities associated with described algorithms, methods, functions, processes, flows, and procedures as described in the instant disclosure, according to an implementation. The illustrated computer 602 is intended to encompass any computing device such as a server, desktop computer, laptop or notebook computer, wireless data port, smart phone, personal data assistant (PDA), tablet computing device, one or more processors within these devices, or any other suitable processing device, including both physical or virtual instances (or both) of the computing device. Additionally, the computer 602 may comprise a computer that includes an input device, such as a keypad, keyboard, touch screen, or other device that can accept user information, and an output device that conveys information associated with the operation of the computer 602, including digital data, visual, or audio information (or a combination of information), or a graphical user interface (GUI).

The computer 602 can serve in a role as a client, network component, a server, a database or other persistency, or any other component (or a combination of roles) of a computer system for performing the subject matter described in the instant disclosure. The illustrated computer 602 is communicably coupled with a network 630. In some implementations, one or more components of the computer 602 may be configured to operate within environments, including cloud-computing-based, local, global, or other environment (or a combination of environments).

At a high level, the computer 602 is an electronic computing device operable to receive, transmit, process, store, or manage data and information associated with the described subject matter. According to some implementations, the computer 602 may also include or be communicably coupled with an application server, e-mail server, web server, caching server, streaming data server, business intelligence (BI) server, or other server (or a combination of servers).

The computer 602 can receive requests over network 630 from a client application (for example, executing on another computer 602) and responding to the received requests by processing the said requests in an appropriate software application. In addition, requests may also be sent to the computer 602 from internal users (for example, from a command console or by other appropriate access method), external or third parties, other automated applications, as well as any other appropriate entities, individuals, systems, or computers.

Each of the components of the computer 602 can communicate using a system bus 603. In some implementations, any or all of the components of the computer 602, both hardware or software (or a combination of hardware and software), may interface with each other or the interface 604 (or a combination of both) over the system bus 603 using an API 612 or a service layer 613 (or a combination of the API 612 and service layer 613). The API 612 may include specifications for routines, data structures, and object classes. The API 612 may be either computer-language independent or dependent and refer to a complete interface, a single function, or even a set of APIs. The service layer 613 provides software services to the computer 602 or other components (whether or not illustrated) that are communicably coupled to the computer 602. The functionality of the computer 602 may be accessible for all service consumers using this service layer. Software services, such as those provided by the service layer 613, provide reusable, defined business functionalities through a defined interface. For example, the interface may be software written in JAVA, C++, or other suitable language providing data in extensible markup language (XML) format or other suitable format. While illustrated as an integrated component of the computer 602, alternative implementations may illustrate the API 612 or the service layer 613 as stand-alone components in relation to other components of the computer 602 or other components (whether or not illustrated) that are communicably coupled to the computer 602. Moreover, any or all parts of the API 612 or the service layer 613 may be implemented as child or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or particular implementations of the computer 602. The interface 604 is used by the computer 602 for communicating with other systems in a distributed environment that are connected to the network 630 (whether illustrated or not). Generally, the interface 604 comprises logic encoded in software or hardware (or a combination of software and hardware) and operable to communicate with the network 630. More specifically, the interface 604 may comprise software supporting one or more communication protocols associated with communications such that the network 630 or interface's hardware is operable to communicate physical signals within and outside of the illustrated computer 602.

The computer 602 includes a processor 605. Although illustrated as a single processor 605 in FIG. 6, two or more processors may be used according to particular needs, desires, or particular implementations of the computer 602. Generally, the processor 605 executes instructions and manipulates data to perform the operations of the computer 602 and any algorithms, methods, functions, processes, flows, and procedures as described in the instant disclosure.

The computer 602 also includes a memory 606 that holds data for the computer 602 or other components (or a combination of both) that can be connected to the network 630 (whether illustrated or not). For example, memory 606 can be a database storing data consistent with this disclosure. Although illustrated as a single memory 606 in FIG. 6, two or more memories may be used according to particular needs, desires, or particular implementations of the computer 602 and the described functionality. While memory 606 is illustrated as an integral component of the computer 602, in alternative implementations, memory 606 can be external to the computer 602.

The application 607 is an algorithmic software engine providing functionality according to particular needs, desires, or particular implementations of the computer 602, particularly with respect to functionality described in this disclosure. For example, application 607 can serve as one or more components, modules, applications, etc. Further, although illustrated as a single application 607, the application 607 may be implemented as multiple applications 607 on the computer 602. In addition, although illustrated as integral to the computer 602, in alternative implementations, the application 607 can be external to the computer 602.

There may be any number of computers 602 associated with, or external to, a computer system that includes computer 602, with each computer 602 communicating over network 630. Further, the term “client,” “user,” and other appropriate terminology may be used interchangeably as appropriate without departing from the scope of this disclosure. Moreover, this disclosure contemplates that many users may use one computer 602, or that one user may use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and Compact Disc Read-Only Memory (CD-ROM), Digital Versatile Disk (DVD)+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), Light Emitting Diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A GUI may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of UI elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a LAN, a radio access network (RAN), a metropolitan area network (MAN), a WAN, Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an API or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described earlier as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described earlier should not be understood as requiring such separation or integration in all implementations, and it should be understood that the described program components and systems can generally be integrated together in a single software product or packaged into multiple software products.

Accordingly, the earlier description of example implementations does not define or constrain this disclosure. Other changes, substitutions, and alterations are also possible without departing from the spirit and scope of this disclosure.

Furthermore, any claimed implementation described later is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for determining a rating score for a supplier, the method being executed by one or more processors and comprising:
receiving, from a client server, transactional data regarding a shipment of goods from the supplier to a client;
determining a score value for each of a plurality of key performance indicators (KPIs) based on the transactional data;
determining an overall rating for the supplier based on a weighted aggregate of the score values and previously determined score values for previous shipments from the supplier to at least one of a plurality of clients, the previously determined score values stored to a distributed ledger;
persisting a new transaction entry for the transactional data to the distributed ledger, wherein new transaction entry includes the score values for each of the KPIs and the overall rating; and
providing the overall rating to a user interface (UI).

2. The computer-implemented method of claim 1, comprising:
prompting a user to enter an evaluation of the shipment; and
receiving, from the UI, an evaluation for the shipment, wherein the new transaction entry includes the evaluation.

3. The computer-implemented method of claim 2, wherein prompting the user includes sending, to the user, an email message or a text message about the shipment.

4. The computer-implemented method of claim 1, comprising:
determining respective ratings scores for other suppliers of the goods from other transaction entries in the distributed ledger for previous shipments from the other suppliers to the clients; and
providing the respective ratings scores for the other suppliers to the UI.

5. The computer-implemented method of claim 1, wherein the KPIs include delivery time accuracy, delivery quantity accuracy, and price accuracy.

6. The computer-implemented method of claim 1, wherein the clients are in a consortium of participating client organizations.

7. The computer-implemented method of claim 1, wherein the transactional data is received through an application programing interface (API) service.

8. The computer-implemented method of claim 1, wherein the transactional data is received based on a triggering of a smart contract condition.

9. The computer-implemented method of claim 1, wherein the transactional data includes an arrival time and date, a quantity of the shipment, a price point of the shipment, purchase order data, goods receipt data, or invoice data.

10. The computer-implemented method of claim 1, comprising:
providing the overall rating to a client application through an application programing interface (API) service.

11. The computer-implemented method of claim 1, wherein the plurality of clients includes the client.

12. One or more non-transitory computer-readable storage media coupled to one or more processors and having instructions stored thereon which, when executed by the one or more processors, cause the one or more processors to perform operations comprising:
receiving, from a client server, transactional data regarding a shipment of goods from a supplier to a client;
determining a score value for each of a plurality of key performance indicators (KPIs) based on the transactional data;
determining an overall rating for the supplier based on a weighted aggregate of the score values and previously determined score values for previous shipments from the supplier to at least one of a plurality of clients, the previously determined score values stored to a distributed ledger;
persisting a new transaction entry for the transactional data to the distributed ledger, wherein new transaction entry includes the score values for each of the KPIs and the overall rating; and
providing the overall rating to a user interface (UI).

13. The one or more non-transitory computer-readable media of claim 12, wherein the operations comprise:
prompting a user to enter an evaluation of the shipment; and
receiving, from the UI, an evaluation for the shipment, wherein the new transaction entry includes the evaluation.

14. The one or more non-transitory computer-readable media of claim 12, wherein the operations comprise:
determining respective ratings scores for other suppliers of the goods from other transaction entries in the distributed ledger for previous shipments from the other suppliers to the clients; and
providing the respective ratings scores for the other suppliers to the UI.

15. A system, comprising:
one or more processors; and
a computer-readable storage device coupled to the one or more processors and having instructions stored thereon which, when executed by the one or more processors, cause the one or more processors to perform operations comprising:
receiving, from a client server, transactional data regarding a shipment of goods from a supplier to a client;
determining a score value for each of a plurality of key performance indicators (KPIs) based on the transactional data;
determining an overall rating for the supplier based on a weighted aggregate of the score values and previously determined score values for previous shipments from the supplier to at least one of a plurality of clients, the previously determined score values stored to a distributed ledger;
persisting a new transaction entry for the transactional data to the distributed ledger, wherein new transaction entry includes the score values for each of the KPIs and the overall rating; and
providing the overall rating to a user interface (UI).

16. The system of claim 15, wherein the clients are in a consortium of participating client organizations.

17. The system of claim 15, wherein the transactional data is received through an application programing interface (API) service.

18. The system of claim 15, wherein the transactional data is received based on a triggering of a smart contract condition.

19. The system of claim 15, wherein the transactional data includes an arrival time and date, a quantity of the shipment, a price point of the shipment, purchase order data, goods receipt data, or invoice data.

20. The system of claim 15, wherein the plurality of clients includes the client.
